(19) United States
(12) Patent Application Publication
(10) Pub. No.: US 2026/0217074 A1
(43) Pub. Date: Jul. 30, 2026

(54) TWO-SHELL CONTROL ARM FOR A WHEEL SUSPENSION OF A MOTOR VEHICLE

(71) Applicant: BENTELER AUTOMOBIL TECHNIK GMBH, Paderborn (DE)

(72) Inventors: Stephan MEYER, Bielefeld (DE); Guido LUETKENHAUS, Bielefeld (DE); Alexander OTT, Geseke (DE)

(21) Appl. No.: 19/455,814

(22) Filed: Jan. 22, 2026

(30) Foreign Application Priority Data
Jan. 23, 2025 (EP) 25153540.7

(51) Int. Cl. B60G 7/00

(52) U.S. Cl. CPC B60G 7/001; B60G 2206/012; B60G 2206/124; B60G 2206/8201

(57) ABSTRACT

A two-shell control arm for a wheel suspension of a motor vehicle, with an upper shell and a lower shell, wherein the control arm has a first end section for connection to the wheel side and a second end section for connection to a chassis support and a control arm section designed as a hollow profile is arranged between the two end sections. The control arm section has cross-sectional profiles with a relative thickness reduction of 25 to 45% along at least 80% of its longitudinal extension.

### RELATED APPLICATIONS

The present application claims priority of European Application Number 25153540.7 filed Jan. 23, 2025, the disclosure of which is hereby incorporated by reference herein in its entirety.

### BACKGROUND

The present disclosure relates to a two-shell control arm for a wheel suspension of a motor vehicle.

In chassis engineering, control arms are components of the wheel suspension of motor vehicles. They guide the wheel support and connect to the wheel support to the vehicle body. Forces and torques acting on the wheel support are transferred into the vehicle body via the control arms.

In order to reduce the consumption of energy required to power motor vehicles and at the same time increase their range, electric cars are designed to be as aerodynamic as possible so that they experience as little air resistance as possible. The aerodynamic design of the underfloor of the vehicles also plays a crucial role.

EP 3 498 504 B1 provides control arms of a wheel suspension of a motor vehicle with aerodynamic fairings or covers which are able to reduce the air resistance of the control arms. These are able to be attached directly to the control arms, as described in US 2007/0096420 A1, or, as taught in U.S. Pat. No. 12,103,352 B2, they cover entire groups of components of the motor vehicle.

However, the use of such fairings involves additional costs and increases the weight of the vehicle. Furthermore, the available installation space in the region of the wheel suspension is very limited, so that attaching the covers to the control arms without impairing the function of the wheel suspension is often not possible.

### SUMMARY

Starting from this, the object of the present disclosure is to provide a control arm for a wheel suspension of a motor vehicle the flow resistance of which is reduced compared to control arms already known.

This object is achieved by a two-shell control arm for a wheel suspension of a motor vehicle.

Embodiments and modifications of features of the control arm according to the present disclosure which, individually or in combination, design and/or refine the present disclosure in a technically advantageous manner is also able to be found in the description and the accompanying drawings.

The control arm according to the present disclosure for a wheel suspension of a motor vehicle is designed as a two-shell structure and has an upper shell and a lower shell. Compared to single-shell control arms, cast iron control arms, the two-shell design of the control arm allows for additional weight savings.

The control arm has a first end section for connection to the wheel side and a second end section for connection to a chassis support. A control arm section designed as a hollow profile is arranged between the two end sections.

The control arm is positioned in the motor vehicle such that the control arm section is arranged transversely in the longitudinal direction, and orthogonally to the longitudinal direction of the motor vehicle.

The control arm section has any number of cross-sectional profiles. A cross-sectional profile corresponds to the cross-section of the control arm section at any point in the longitudinal direction between the first end section and the second end section.

A cross-sectional profile is able to be characterized by its profile depth, maximum profile thickness, thickness reduction, relative profile thickness, and relative thickness reduction. These geometric characteristic values are able to be determined for each cross-sectional profile along the longitudinal direction of the control arm section.

The profile depth corresponds to the distance between a profile nose and a profile trailing edge of the cross-sectional profile. The profile nose is oriented towards the front of the motor vehicle, while the profile trailing edge is oriented towards the rear of the vehicle.

The maximum profile thickness indicates the maximum distance between a top surface of the cross-sectional profile contour and a bottom surface of the cross-sectional profile contour.

The thickness reduction is a measure of the distance between the profile nose and the maximum profile thickness measured along the profile depth of a cross-sectional profile. The thickness reduction corresponds approximately to the location of the maximum flow velocity and the lowest static pressure.

The relative thickness reduction is the ratio of the thickness reduction to the profile depth, and is expressed as a percentage.

The relative profile thickness is the ratio of the maximum profile thickness to the profile depth, and is also expressed as a percentage.

In at least one embodiment of the present disclosure, the control arm section has cross-sectional profiles with a relative thickness reduction of 25% to 45% along at least 80% of its longitudinal extension. This means that the distance between the profile nose and the maximum profile thickness, i.e. the thickness reduction, corresponds to only 25 to 45% of the profile length of the respective cross-sectional profile. In the region of the thickness reduction, a stable and smooth flow is generated. Within the scope of the present disclosure, the drag coefficient (cw value) of the control arm is able to be reduced by a value of more than 0.05 compared to other control arms through the design of the control arm section according to the present disclosure. Control arms sometimes have cross-sectional profiles with a substantially constant profile width along the longitudinal extension of the control arm section, so that no maximum profile width is formed in the sense of the present disclosure. Furthermore, control arms are able to have the maximum profile width formed directly at the profile nose or at the profile trailing edge. Only through the present disclosure thickness reduction of the cross-sectional profiles is the aerodynamics of the control arm improved to such an extension that no additional covers are required.

The outer contour of the cross-sectional profiles of the control arm section is therefore in a teardrop-shaped. The contour of the cross-sectional profiles is rounded in the region of the profile nose. This is followed by a gradual increase in profile thickness until the maximum profile thickness is reached. Starting from the maximum profile thickness, the profile thickness decreases continuously until the trailing edge of the profile, which is also rounded.

In at least one embodiment of the present disclosure, the control arm section has cross-sectional profiles with a relative thickness reduction of 25% to 45% along at least 90% of its longitudinal extension. This reduces the flow resistance of the control arms.

In at least one embodiment of the present disclosure, the cross-sectional profiles have a relative thickness reduction of 30% to 40%, or 33% to 38%. These value ranges have proven to be advantageous for reducing the air resistance of the control arms within the scope of the present disclosure.

The cross-sectional profiles have a thickness of 30 mm to 70 mm, or 35 mm to 50 mm.

In at least one embodiment of the present disclosure, the cross-sectional profiles have a relative profile thickness of 30% to 50%, 35% to 45%, and 40% to 45%.

The cross-sectional profiles have a profile depth of 80 mm to 200 mm, 80 mm to 170 mm, 90 mm to 160 mm, and lastly 100 mm to 150 mm.

The maximum profile thickness of the cross-sectional profiles is 35 mm to 70 mm, and 40 mm to 60 mm.

The upper and lower shells of the two-shell control arm are joined together, e.g., welded. This ensures a secure hold between the shells.

In at least one embodiment of the present disclosure, the upper shell and the lower shell are butt-jointed on the side of the control arm section oriented towards the front of the motor vehicle, i.e., in the region of the profile nose of the cross-sectional profiles. The profile nose therefore exhibits no irregularities that could lead to an unfavorable turbulence of the airflow striking the profile nose.

In at least one embodiment of the present disclosure, the upper shell and the lower shell are joined with overlap on the side of the control arm section oriented towards the rear of the motor vehicle, i.e., in the region of the profile trailing edge. The overlap of the upper and lower shells is thus formed at the trailing edge of the cross-sectional profile. The overlap simplifies the joining of the shells and allows for tolerance compensation. Furthermore, it has been shown within the scope of the present disclosure that an overlap of the shells at the trailing edge of the cross-sectional profiles does not negatively affect the flow and therefore does not lead to a higher flow resistance of the control arm.

The control arm is designed as a transverse control arm and is able to have an additional control arm which is also able to be connected to a chassis support via a third end section. The third end section is arranged at the end of the control arm, wherein the control arm is designed as a hollow profile and adjoins the control arm section on the side adjacent to the second end section.

The control arms are made of a steel material.

The present disclosure also includes a motor vehicle in which a control arm according to the present disclosure is arranged with any combination of the aforementioned features.

### BRIEF DESCRIPTION OF THE DRAWINGS

The present disclosure is described in more detail hereinafter on the basis of purely schematic drawings. In the figures:

FIG. 1 shows a control arm according to the invention in a top view;

FIG. 2A shows the control arm according to at least one embodiment in section A-A of FIG. 1,

FIG. 2B shows the control arm according to at least one embodiment in section B-B of FIG. 1, and

FIG. 2C shows the control arm according to at least one embodiment in section C-C of FIG. 1.

### DETAILED DESCRIPTION

The same reference numerals are used for same or corresponding components, although a repeated description is omitted for reasons of simplicity.

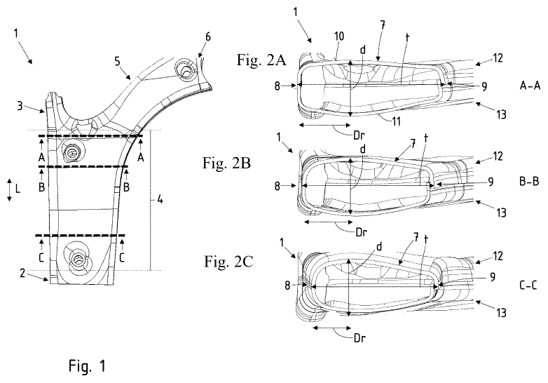

FIG. 1 shows a control arm 1 according to the present disclosure for a wheel suspension of a motor vehicle not shown in detail in a top view.

The control arm 1 is a transverse control arm. The transverse control arm is designed as a triangular link.

The control arm 1 according to the present disclosure has a first end section 2 for connection to the wheel side and a second end section 3 for connection to a chassis support, which is not shown in further detail. The end sections 2 and 3 are only indicated in FIG. 1, and the corresponding bearing mounts are not shown.

A control arm section 4 designed as a hollow profile is arranged between the two end sections 2, 3. The control arm 1 is positioned in the motor vehicle such that the control arm section 4 is arranged with its longitudinal extension L transversely to the longitudinal direction, orthogonally to the longitudinal direction of the motor vehicle, which is not shown in detail.

The control arm 1 has an additional control arm 5 with a third end section 6, which is only indicated in FIG. 1 and is also designed for connection to a chassis support. The control arm 5 transitions into the control arm section 4 adjacent to the second end section 3. The control arm 1 is also able to have only two end sections 2, 3 and a control arm section 4 arranged in between.

FIG. 2A, FIG. 2B, and FIG. 2C show the control arm 1 depicted in FIG. 1 in cross-sectional views A-A, B-B and C-C. The cross-sectional views show different cross-sectional profiles 7 along the longitudinal extension L of the control arm section 4.

The cross-sectional profiles 7 shown each have a profile nose 8 and a profile trailing edge 9. The profile nose 8 is oriented towards the front of the motor vehicle. When the motor vehicle is traveling in a forward direction, the profile nose 8 of the cross-sectional profile 7 of the control arm section 4 is thus in the wind and is the first to come into contact with the airflow. The profile trailing edges 9 of the cross-sectional profiles 7 are therefore oriented towards the rear of the motor vehicle.

The cross-sectional profiles 7 have a profile depth t of 100 mm to 200 mm. The profile depth t corresponds to the distance between the profile nose 8 and the profile trailing edge 9. The profile depth t of the cross-sectional profiles 7 of the control arm section 4 increases from the first end section 2 to the second end section 3.

The cross-sectional profiles 7 also have a maximum profile thickness d of 40 mm to 70 mm. The maximum profile thickness d indicates the maximum distance between a top side 10 and a bottom side 11 of the cross-sectional profiles 7, and is able to be defined as the maximum height of the respective cross-sectional profile 7. The maximum profile thickness d is orthogonal to the profile depth t.

The respective cross-sectional profiles 7 have a thickness reduction Dr of 35 mm to 70 mm. The thickness reduction Dr characterizes the distance between the profile nose 8 and the maximum profile thickness d measured along the profile depth t.

According to the present disclosure, the control arm section 4 has cross-sectional profiles 7 with a relative thickness reduction rDr of 25% to 45% along at least 80% of its longitudinal extension L. The relative thickness reduction rDr is the ratio between the thickness reduction Dr and the profile depth t of the respective cross-sectional profile 7, and is given as a percentage and calculated using the following formula:

$$r D r = \frac{D r}{t} 100 [ \% ]$$

Due to the relative thickness reduction rDr according to the present disclosure, the cross-sectional profiles 7 have a teardrop shape. Starting from the profile nose 8, the contour of the cross-sectional profiles 7 widens with a rounding until the characteristic maximum profile thickness d is reached. Once the maximum profile thickness d has been reached, the profile thickness of the cross-sectional profiles 7 decreases continuously and the contour transitions into the also rounded profile trailing edge 9. The distance between the profile nose 8 and the maximum profile thickness d, which is specified by the thickness reduction Dr, is significantly less than the distance between the maximum profile thickness d and the profile trailing edge 9. This design of the control arm section 4 has proven to be advantageous for reducing the flow resistance of the control arm 1 within the scope of the present disclosure. Therefore, additional covers to improve the aerodynamics of control arm 1 are able to be omitted.

The respective cross-sectional profiles 7 also have a relative profile thickness rD of 40% to 45%. The relative profile thickness rD is the ratio of the maximum profile thickness d to the profile depth t. The relative profile thickness rD is also given as a percentage and is calculated as follows:

$$r D = \frac{d}{t} 100 [ \% ]$$

FIG. 2A, FIG. 2B, and FIG. 2C also shows that the control arm 1 is designed as a two-shell structure and has an upper shell 12 and a lower shell 13. The upper shell 12 and the lower shell 13 are welded together.

In the region of the profile nose 8 of the cross-sectional profiles 7 of the control arm section 4, the shells 12, 13 are butt-jointed. Since the profile nose 8 is oriented towards the front of the vehicle, this is the first part to be hit by the flow generated by the driving. To avoid aerodynamically unfavorable turbulence at this point, the upper shell 12 and the lower shell 13 are therefore butt-welded so that the smallest possible irregularities are created at this point.

At the rear edge 9 of the cross-sectional profiles 7 of the control arm section 4, the upper shell 12 and the lower shell 13 are welded together overlapping. The overlap allows stresses between the upper shell 12 and the lower shell 13 to be balanced. Furthermore, the scope of the present disclosure shows that a corresponding overlap of the shells 12, 13 at the profile trailing edge 9 does not have a detrimental effect on the flow resistance of the control arm 1.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-10. (canceled)

11. A two-shell control arm for a wheel suspension of a motor vehicle, the two-shell control arm comprising:
a lower shell,
an upper shell connected to the lower shell,
a first end section configured to be connected to a wheel side,
a second end section configured to be connected to a chassis support, and
a control arm section comprising a hollow profile, wherein
the control arm section is arranged between the first and second end sections of the two-shell control arm, and
the control arm section comprises, along at least 80% of a longitudinal extension of the control arm section between the first and second end sections, cross-sectional profiles each with a relative thickness reduction of 25 to 45%.

12. The control arm according to claim 11, wherein the control arm section comprises, along at least 90% of the longitudinal extension of the control arm section, cross-sectional profiles each with a relative thickness reduction of 25 to 45%.

13. The control arm according to claim 11, wherein each of the cross-sectional profiles has a relative thickness reduction of 30 to 40%.

14. The control arm according to claim 11, wherein each of the cross-sectional profiles has a thickness reduction of 30 to 70 mm.

15. The control arm according to claim 11, wherein each of the cross-sectional profiles has a relative profile thickness of 30 to 50%.

16. The control arm according to claim 11, wherein each of the cross-sectional profiles has a profile depth of 80 mm to 200 mm.

17. The control arm according to claim 11, wherein each of the cross-sectional profiles has a maximum profile thickness of 35 mm to 70 mm.

18. The control arm according to claim 11, wherein the upper shell and the lower shell are welded together.

19. The control arm according to claim 18, wherein the upper shell and the lower shell are joined together in a region of a profile nose of each of the cross-sectional profiles.

20. The control arm according to claim 18, wherein the upper shell and the lower shell are joined together in an overlapping manner in a region of a profile trailing edge of each of the cross-sectional profiles.

21. The control arm according to claim 11, wherein the control arm section has, along the entire longitudinal extension of the control arm section, cross-sectional profiles each with a relative thickness reduction of 25 to 45%.

22. The control arm according to claim 11, wherein each of the cross-sectional profiles has a relative thickness reduction of 33 to 38%.

23. The control arm according to claim 11, wherein each of the cross-sectional profiles has a thickness reduction of 35 to 60 mm.

24. The control arm according to claim 11, wherein each of the cross-sectional profiles has a relative profile thickness of 35 to 45%.

25. The control arm according to claim 11, wherein each of the cross-sectional profiles has a relative profile thickness of 40 to 45%.

26. The control arm according to claim 11, wherein each of the cross-sectional profiles has a profile depth 80 mm to 170 mm.

27. The control arm according to claim 11, wherein each of the cross-sectional profiles has a profile depth of 90 mm to 160 mm.

28. The control arm according to claim 11, wherein each of the cross-sectional profiles has a profile depth of 100 mm to 150 mm.

29. The control arm according to claim 11, wherein each of the cross-sectional profiles has a maximum profile thickness of 40 mm to 60 mm.

30. The control arm according to claim 11, wherein each of the cross-sectional profiles has:
a profile nose configured to be oriented towards a front of the motor vehicle,
a profile trailing edge configured to be oriented towards a rear of the motor vehicle,
a profile depth (t) corresponding to a distance between the profile nose and the profile trailing edge,
a maximum profile thickness (d) indicating a maximum height of the cross-sectional profile between a top side and a bottom side of the cross-sectional profile,
a thickness reduction (Dr) corresponding to a distance, along the profile depth, between the profile nose and a portion with the maximum profile thickness, and
the relative thickness reduction (rDr) calculated as rDr=Dr/t×100 [%], wherein rDr is from 25 to 45%.
